(19) United States
(12) Patent Application Publication
(10) Pub. No.: US 2010/0212340 A1
(43) Pub. Date: Aug. 26, 2010

(54) GEAR MECHANISM, ICE MAKING DEVICE AND ASSEMBLING METHOD FOR GEAR MECHANISM

(75) Inventor: Hiroki KURATANI, Nagano (JP)

Correspondence Address: CANTOR COLBURN, LLP, 20 Church Street, 22nd Floor, Hartford, CT, 06103, US

(73) Assignee: NIDEC SANKYO CORPORATION, Nagano (JP)

(21) Appl. No.: 12/390,104

(22) Filed: Feb. 20, 2009

(51) Int. Cl. F25C 1/00; F25C 5/18; B23P 19/04; F16H 1/20

(52) U.S. Cl. 62/137; 62/344; 29/700; 74/413

(57) ABSTRACT

A gear mechanism may include a first gear for operating a first drive object a second gear for operating a second drive object in cooperation with the first drive object and a third gear connected with a drive source. The second gear may include a small gear part engaged with the first gear, and a large gear part engaged with the third gear. An end face of the second gear on the large gear part side may be formed with a flange part and the flange part is formed with a cutout part for allowing the large gear part to engage with the third gear. The gear mechanism may be preferably applied to an ice making device. An assembling method for the gear mechanism may utilize a previously formed mark part on the first gear for determining a position in a circumferential direction of the first gear with respect to the case body and a previously formed positioning recessed part in the small gear part of the second gear so that a positioning pin is capable of being engaged with the positioning recessed part.

### FIELD OF THE INVENTION

At least an embodiment of the present invention may relate to a gear mechanism, an ice making device provided with the gear mechanism, and an assembling method for the gear mechanism.

### BACKGROUND OF THE INVENTION

An ice making device for automatically making ice pieces has been conventionally known which includes an ice tray, an ice detecting lever, and a drive mechanism for driving the ice tray and the ice detecting lever in an interlocked manner (see, for example, Japanese Patent Laid-Open No. Hei 6-265249). The drive mechanism in the ice making device which is disclosed in the Patent Reference is provided with a shaft which is connected with the ice tray, an ice detecting shaft which is turned together with the ice detecting lever in an integrated manner, and a cam for turning the ice detecting shaft Further, the drive mechanism is provided with a motor which is a drive source for driving the ice tray and a gear train for transmitting power from the motor to a shaft, and the cam is integrally formed on a gear which structures the gear train.

When the ice tray is to be operated in an interlocked manner with the ice detecting lever like the ice making device described in the above-mentioned Patent Reference, in order to properly operate the ice tray and the ice detecting lever, the gear train is required to be assembled so that initial positions of the ice tray and the ice detecting lever are appropriately located. Therefore, assembling of the gear train becomes complicated.

### SUMMARY OF THE INVENTION

In view of the problems described above, at least an embodiment of a gear mechanism may drive two drive objects which are interlocked with each other, in which alignment of a plurality of gears is capable of being easily performed to attain easy assembling. Further, at least an embodiment of the present invention may advantageously provide an ice making device may be provided with the above-mentioned gear mechanism. In addition, at least an embodiment may advantageously provide an assembling method for the above-mentioned gear mechanism.

At least an embodiment of a gear mechanism may include a first gear for operating a first drive object a second gear for operating a second drive object in cooperation with the first drive object and a third gear which is connected with a drive source. The second gear includes a small gear part which is engaged with the first gear, and a large gear part having a diameter larger than the small gear part and which is engaged with the third gear. The small gear part and the large gear part are disposed so as to be superposed on each other in an axial direction, and an end face of the second gear on the large gear part side is formed with a flange part which is formed in a radial direction, and the flange part is formed with a cutout part for allowing the large gear part to engage with the third gear.

In at least an embodiment of the gear mechanism, the flange part which is formed on an end face of the second gear on a large gear part side is formed with a cutout part for allowing the large gear part to engage with the third gear. Therefore, even when the small gear part and the large gear part are disposed so as to be superposed on each other in an axial direction, and the flange part is formed on the end face of the second gear on the large gear part side, the third gear and the large gear part can be engaged with each other after the first gear and the small gear part have been engaged with each other. In other words, in order to properly operate the first drive object and the second drive object which are to be interlocked with each other, after alignment of the first gear with the second gear which is required to be aligned with each other has been performed, the third gear and the large gear part in which alignment is not required is engaged with each other. Therefore, alignment of the first gear with the second gear can be performed easily and thus assembling for the gear mechanism can be performed easily.

In at least an embodiment, the first gear and the third gear are coaxially disposed on each other. In this case, it is preferable that an engagement part is formed on a face of the first gear, which is opposite to a side where the third gear is disposed, for being engaged with the first drive object to operate the first drive object and the flange part which is formed on the end face on the large gear part side of the second gear is formed in a larger diameter than a tooth bottom of the large gear part, and a cam part is formed on the flange part for operating the second drive object, and the cutout part which is formed in the flange part is formed at a different position in a circumferential direction from the cam part so that the tooth bottom of the large gear part is exposed.

Further, an embodiment of a cam part may be formed on the flange part for operating the second drive object. In this case, the cam can be formed with a high degree of accuracy in comparison with a case where the cam is formed on an end face on the small gear part side of the second gear. Further, in this case, it is preferable that a rotation range of the second gear is less than one revolution According to is structure, the cutout part is formed by utilizing a portion of the flange part where the cam is not formed.

At least an embodiment of the gear mechanism may be provided with a case body on which the first gear and the second gear are turnably mounted, and an insertion hole is formed in the case body into which a positioning pin is capable of being inserted for determining a position in a circumferential direction of the second gear. In this case, it is preferable that a positioning recessed part is formed in the small gear part of the second gear so that the positioning pin is capable of being engaged with the positioning recessed part. According to this structure, the position of the second gear with respect to the case body can be determined easily by utilizing the positioning pin which is inserted into the insertion hole. Further, since the positioning pin is pulled out from the insertion hole after having been assembled, the positioning pin does not affect the operation of the gear mechanism.

In at least an embodiment, a rotation range of the second gear is less than one revolution, the small gear part is formed with a toothless part where a tooth is not formed, and the positioning recessed part is formed on an outer peripheral face of the toothless part. According to this structure, the positioning recessed part is formed by utilizing the toothless part which is not used for the operation of the gear mechanism. As a result, the structure of the second gear can be simplified Further, the size in the radial direction of the second gear can be reduced

At least an embodiment of the gear mechanism may be provided with a case body on which the first gear and the second gear are turnably mounted, and a mark part is formed on the first gear for determining a position in a circumferential direction of the first gear with respect to the case body. According to this structure, the position of the first gear with respect to the case body can be determined easily by utilizing the mark part.

At least an embodiment of an engagement part may be formed on a face of the first gear, which is opposite to a side where the third gear is disposed, for being engaged with the first drive object to operate the first drive object, and a cam part is formed on the flange part for operating the second drive object, and an insertion hole is formed in the case body and into which a positioning pin is capable of being inserted for determining a position in a circumferential direction of the second gear, and a position in a circumferential direction of the engagement part for operating the first drive object is determined by utilizing the mark part formed on the first gear which is set at a predetermined position in a circumferential direction of the first gear, and a position in the circumferential direction of the second gear is determined by the positioning pin, thereby the position of the engagement part for operating the first drive object and the position of the cam part for operating the second drive object are set in a predetermined positional relationship.

At least an embodiment of the gear mechanism may be used in an ice making device which is provided with a drive source, an ice tray as the first drive object and an ice detecting lever for detecting a remaining amount of ice pieces in an ice storage container in which ice pieces made in the ice tray are stored as the second drive object. In the ice making device, alignment of the first gear with the second gear structuring the gear mechanism is performed easily and thus the gear mechanism can be assembled easily.

At least an embodiment of the ice making device may include a crank which is engaged with the ice tray for moving the ice tray to a water-supply position where water is supplied into the ice tray and to an ice making position where water in the ice tray is made frozen, a crank turning shaft by which the crank is turned, and a lever turning shaft by which the ice detecting lever is turned. The first gear is formed with a shaft engaging recessed part with which an end part of the crank turning shaft is engaged and the flange part is formed with a cam for turning the lever turning shaft.

At least an embodiment of the gear mechanism may be assembled by the steps of mounting the first gear on a case body, after that, mounting the second gear on the case body to engage the first gear with the small gear part and then, the third gear is engaged with the large gear part through the cutout part According to this assembling method, alignment of the first gear with the second gear is performed easily and thus the gear mechanism can be assembled easily.

In at least an embodiment, an insertion hole is previously formed in the case body into which a positioning pin is capable of being inserted for determining a position in a circumferential direction of the second gear, and a positioning recessed part is previously formed in the small gear part of the second gear so that the positioning pin is capable of being engaged with the positioning recessed part and, in a state where the positioning pin is inserted into the insertion hole, the second gear is mounted on the case body so that the positioning pin and the positioning recessed part are engaged with each other According to this assembling method, the position of the second gear with respect to the case body can be determined easily by utilizing the positioning pin which is inserted into the insertion hole.

In at least an embodiment a mark part is previously formed on the first gear for determining a position in a circumferential direction of the first gear with respect to the case body, and the first gear is mounted on the case body by utilizing the mark part as a mark. According to this assembling method, the position of the first gear with respect to the case body can be determined easily by utilizing the mark part.

In at least an embodiment an engagement part is previously formed on a face of the first gear, which is opposite to a side where the third gear is disposed, for being engaged with the first drive object to operate the first drive object and the mark part which is formed on the first gear at a position in a circumferential direction of the first gear is previously formed at a predetermined position so that a position in a circumferential direction of the engagement part for operating the first drive object is determined at a predetermined position. Further, a cam part is previously formed on the flange part for operating the second drive object and an insertion hole is previously formed in the case body into which a positioning pin is capable of being inserted for determining a position in a circumferential direction of the second gear. Further, a positioning recessed part is previously formed in the small gear part of the second gear so that the positioning pin is capable of being engaged with the positioning recessed part. Therefore, the first gear is set at a predetermined position in the circumferential direction of the first gear by utilizing the mark part and the second gear is set at a predetermined position in the circumferential direction of the second gear by engaging the positioning pin with the positioning recessed part in a state where the positioning pin is inserted into the insertion hole and, thereby the position of the engagement part for operating the first drive object and the position of the cam part for operating the second drive object are set in a predetermined positional relationship.

Other features and advantages of the invention will be apparent from the following detailed description, taken in conjunction with the accompanying drawings that illustrate, by way of example, various features of embodiments of the invention.

### BRIEF DESCRIPTION OF THE DRAWINGS

Embodiments will now be described, by way of example only, with reference to the accompanying drawings which are meant to be exemplary, not limiting, and wherein like elements are numbered alike in several Figures, in which:

FIG. 1 is a perspective view showing an ice making device in accordance with at least an embodiment.

FIG. 2 is a perspective view showing the ice making device shown in FIG. 1 which is viewed from a different direction.

FIG. 3 is a perspective view showing a state where an ice tray and the like are detached from the ice making device shown in FIG. 1, and which is viewed from a different direction.

FIG. 4 is a right side view showing the ice making device shown in FIG. 1.

FIG. 5 is a perspective view showing a state where a motor, a cover member and the like are detached from the ice making device shown of FIG. 1, and which is viewed from a different direction.

FIG. 6 is a perspective view showing a gear mechanism shown in FIG. 5.

FIG. 7 is an exploded perspective view showing the gear mechanism shown in FIG. 6.

FIG. 8 is a perspective view showing a first gear shown in FIG. 7.

FIG. 9 is a left side view showing the first gear shown in FIG. 7.

FIG. 10 is a perspective view showing a second gear in FIG. 7.

FIG. 11 is a left side view showing the second gear in FIG. 7.

FIG. 12 is a perspective view for explaining a step in which the first gear and the second gear are mounted on a case body shown in FIG. 7.

FIG. 13 is a perspective view for explaining a mounting step in which the second gear is mounted on the case body shown in FIG. 7.

FIG. 14 is a perspective view for explaining a mounting step in which the second gear and a third gear shown in FIG. 7 are engaged with each other.

FIGS. 15(A) through 15(E) are views for explaining an ice making operation in the ice making device shown in FIG. 1.

FIGS. 16(A) through 16(C) are views for explaining movement of an ice detecting lever shown in FIG. 1.

### DETAILED DESCRIPTION OF THE PREFERRED EMBODIMENTS

At least an embodiment will be described below with reference to the drawings.

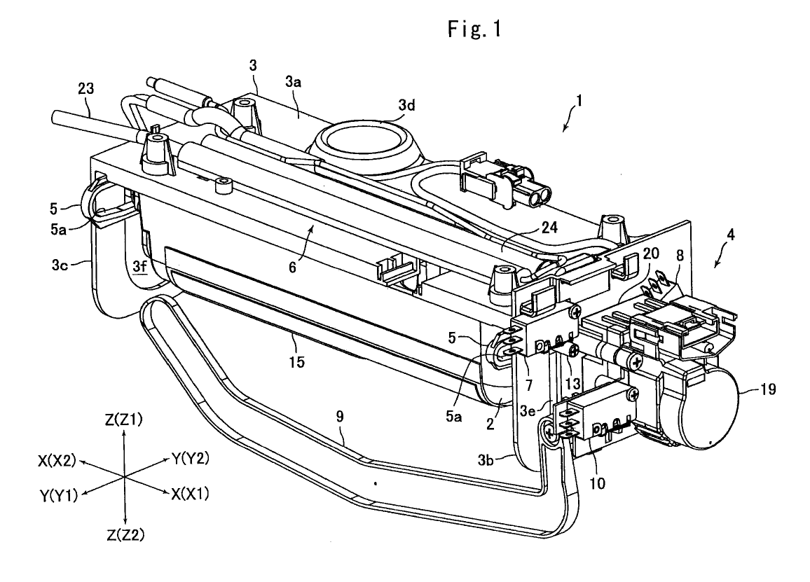

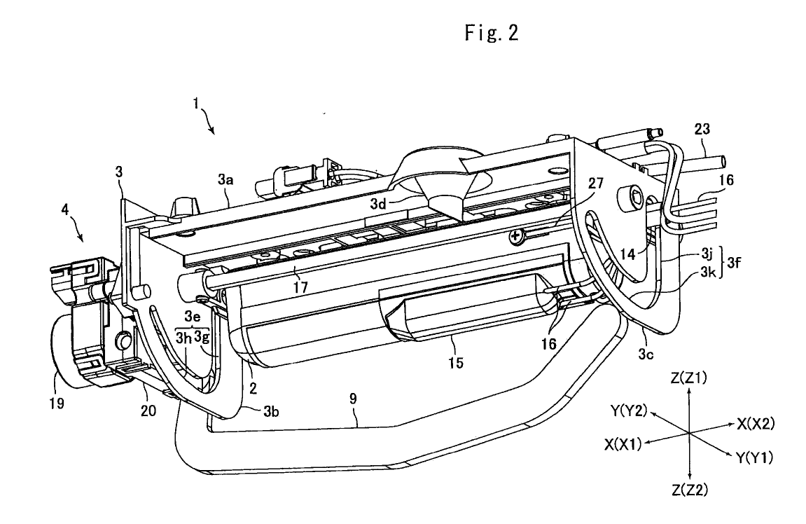

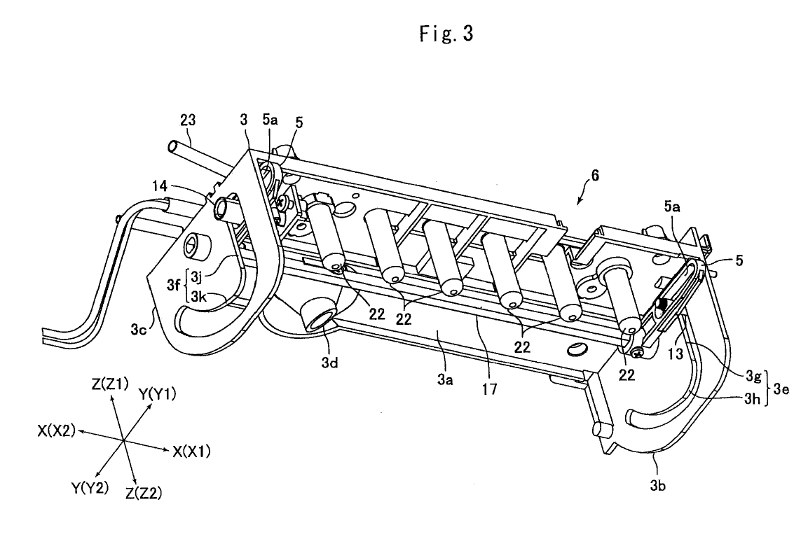

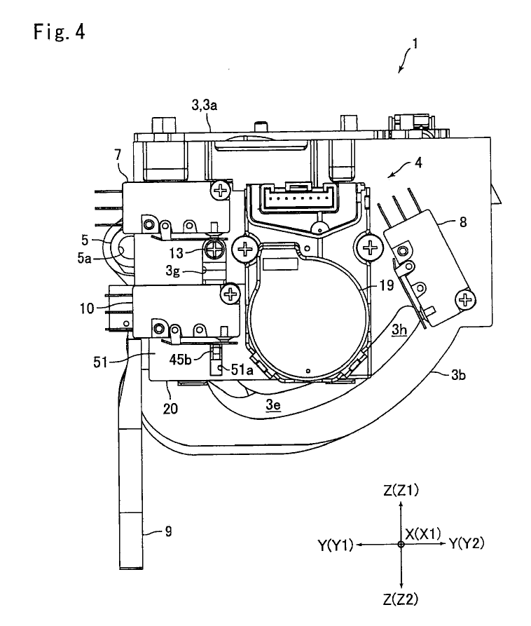

FIG. 1 is a perspective view showing an ice making device 1 in accordance with an embodiment of the present invention FIG. 2 is a perspective view showing the ice making device 1 shown in FIG. 1 which is viewed from a different direction. FIG. 3 is a perspective view showing a state where an ice tray 2 and the like are detached from the ice making device 1 shown in FIG. 1, and which is viewed from a different direction FIG. 4 is a right side view showing the ice making device in FIG. 1.

In the following description, as shown in FIG. 1 and the like, three directions perpendicular to each other are set to be an X direction, a Y-direction and a Z-direction. Further, in the following description, an X1-direction side is set to be a “right” side, an X2-direction side is set to be a “left” side, a Y1-direction side is set to be a “front (or before)” side, a Y2-direction side is set to be a “rear” (or back) side, a Z1-direction side is set to be an “upper” side, and a Z2-direction side is set to be a “lower” side. Further, in the following description, a plane which is formed by the X-direction and the Y-direction is set to be an XY-plane, and a plane which is formed by the Y-direction and the Z-direction is set to be a YZ-plane.

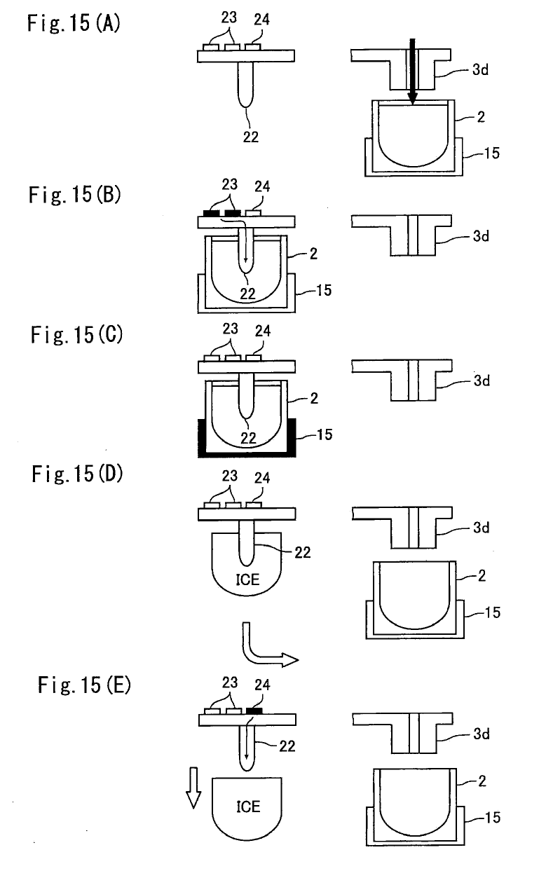

The ice making device 1 in this embodiment is, for example, used in a refrigerator for automatically making ice pieces. The ice making device 1 is provided with an ice tray 2 and the ice tray 2 is moved to a water-supply position where water is supplied to the ice tray 2 and to an ice making position where water in the ice tray 2 is made frozen. In this embodiment, the position of the ice tray 2 when the ice tray 2 is disposed on an underside of a water-supply part 3d is a water-supply position (see FIG. 15(A)), and the position of the ice tray 2 when cooling bodies 22 described below are entered into the ice tray 2 is an ice making position (see FIG. 15(B)).

The ice making device 1 includes the ice tray 2, a frame 3, a drive mechanism 4 for moving the ice tray 2 to the water-supply position and to the ice making position, two cranks 5 which are connected with the drive mechanism 4 for moving the ice tray 2, a cooling mechanism 6 for freezing water in the ice tray 2, a first sensor 7 and a second sensor 8 for detecting a position of the ice tray 2, an ice detecting lever 9 for detecting a remaining amount of ice pieces in an ice storage container (not shown) where ice pieces are stored, and a third sensor 10 for detecting a position of the ice detecting lever 9. The ice making device 1 in this embodiment is structured so that the ice tray 2 and the ice detecting lever 9 are interlocked with each other by power of the drive mechanism 4.

The frame 3 includes a top plate part 3a which is parallel to the XY-plane and formed in a roughly flat plate shape, and two side plate parts 3b and 3c which are parallel to the YZ-plane and formed in a roughly flat plate shape. The frame 3 is, as a whole, formed in a roughly rectangular groove shape. The side plate part 3b is formed downward from a right-side end of the top plate part 3a and the side plate part 3c is formed downward from a left-side end of the top plate part 3a.

A water-supply part 3d for supplying water into the ice tray 2 is formed on the back end side of the top plate part 3a. A water-supply mechanism not shown in the drawing is connected with an upper end of the water-supply part 3d and water is supplied into the ice tray 2 from a lower end of the water-supply part 3d.

The side plate part 3b is formed with a guide groove 3e, which penetrates through the side plate part 3b, for guiding the ice tray 2 to the water-supply position and to the ice making position. Similarly, the side plate part 3c is formed with a guide groove 3f, which penetrates through the side plate part 3c, for guiding the ice tray 2 to the water-supply position and to the ice making position.

The guide groove 3e is formed so that its shape viewed from the right and left direction is in a substantially “J” shape. Specifically, as shown in FIGS. 2 and 3, the guide groove 3e is structured of a first groove part 3g, which is substantially parallel to the vertical direction and formed in a straight-line shape, and a second groove part 3h which is formed in a curved-shape. The first groove part 3g is formed on a front end side of the side plate part 3b. The second groove part 3h is formed to be connected with a lower end of the first groove part 3g and formed toward the back side from the lower end of the first groove part 3g. Further, the second groove part 3h is gradually curved in an upper direction toward the back side.

Similarly, the guide groove 3f is formed so that its shape viewed from the right and left direction is in a substantially “J” shape. In other words, the guide groove 3f is structured of a first groove part 3j, which is substantially parallel to the vertical direction and formed in a straight-line shape, and a second groove part 3k which is formed in a curved-shape. The first groove part 3j is formed on a front end side of the side plate part 3c. The second groove part 3k is formed to be connected with a lower end of the first groove part 3j and formed toward the back side from the lower end of the first groove part 3j. Further, the second groove part 3k is gradually curved in an upper direction toward the back side. In this embodiment a width of the guide groove 3f is set to be wider than a width of the guide groove 3e.

The ice tray 2 is disposed on a lower side of the top plate part 3a and between the side plate parts 3b and 3c in the right and left direction. A cylindrical engaging pin 13 which engages with the guide groove 3e is mounted on the right-side end of the ice tray 2 so as to protrude in the right direction. An engaging tube 14 having a substantially cylindrical shape which engages with the guide groove 3f is mounted on the left-side end of the ice tray 2 so as to protrude in the left direction.

The engaging pin 13 and the engaging tube 14 are mounted on the ice tray 2 so that an axial direction of the engaging pin 13 substantially coincides with the axial direction of the engaging tube 14. Further, the engaging pin 13 and the engaging tube 14 are mounted on an upper end side of the ice tray 2. Further, the engaging pin 13 and the engaging tube 14 are mounted at a roughly center position of the ice tray 2 in the front and rear direction. An outer diameter of the engaging pin 13 is set to be smaller than a width of the guide groove 3e. Further, an outer diameter of the engaging tube 14 is set to be smaller than a width of the guide groove 3f.

The engaging pin 13 is inserted into the guide groove 3e and a drive groove 5a which is formed in the crank 5. The right-side end of the engaging pin 13 is protruded toward the right side from the right side face of the side plate part 3b. Further, the engaging tube 14 is inserted into a drive groove 5a and the guide groove 3f, and the left-side end of the engaging tube 14 is protruded toward the left side from the left side face of the side plate part 3c.

As shown in FIG. 2, a heater 15 is mounted on an under face of the ice tray 2. Connecting wires 16 are connected to the heater 15. The connecting wires 16 are drawn out to the left side from the ice making device 1 so as to pass through the inner side of the engaging tube 14.

One end side of the crank 5 is fixed to a crank turning shaft 17, whose both ends are turnably supported by the side plate parts 3b and 3c of the frame 3, and the crank 5 is turnable with the crank turning shaft 17 as its center. Two cranks 5 are disposed on inner sides of the side plate parts 3b and 3c in the right and left direction. Further, the two cranks 5 are disposed on outer sides of the ice tray 2 in the right and left direction.

The crank 5 is formed with the drive groove 5a, with which the engaging pin 13 or the engaging tube 14 is engaged, so as to penetrate through the crank 5 in the right and left direction and which is formed in a substantially linear manner. A width of the drive groove 5a with which the engaging pin 13 is engaged is set to be larger than an outer diameter of the engaging pin 13. Further, a width of the drive groove 5a with which the engaging tube 14 is engaged is set to be larger than an outer diameter of the engaging tube 14.

The crank turning shaft 17 is held by the side plate parts 3b and 3c on upper end sides of the side plate parts 3b and 3c. Further, in the front and rear direction, the crank turning shaft 17 is disposed at roughly center positions of the side plate parts 3b and 3c. The right-side end of the crank turning shaft 17 is connected with a gear mechanism 20 which structures the drive mechanism 4.

In this embodiment, when the crank 5 is turned with the crank turning shaft 17 as its turning center, the engaging pin 13 and the engaging tube 14 which engage with the drive grooves 5a are moved along the guide grooves 3e and 3f. In other words, when the cranks 5 are turned with the crank turning shaft 17 as its center, the ice tray 2 is moved along the guide grooves 3e and 3f.

The drive mechanism 4 is provided with a motor 19 as a drive source and a gear mechanism 20 for transmitting power of the motor 19 to the crank turning shaft 17. The gear mechanism 20 is fixed to a right side face of the side plate part 3b. Further, the motor 19 is fixed to a right side face of the gear mechanism 20. The motor 19 in this embodiment is a geared motor having a deceleration mechanism (not shown). A detailed structure of the gear mechanism 20 will be described below.

The cooling mechanism 6 is provided with a plurality of cooling bodies 22 for freezing water which enter into the ice tray 2 from an upper side of the ice tray 2 located at the ice making position, a refrigerant pipe 23 through which refrigerant for cooling the cooling bodies 22 is passed, and a heater 24 for heating the cooling bodies 22 when ice pieces stuck to the cooling bodies 22 are to be dropped. The cooling bodies 22 are, as shown in FIG. 3, mounted on the top plate part 3a so as to protrude downward from the front end side of the top plate part 3a of the frame 3. The refrigerant pipe 23 and the heater 24 are mounted on an upper face of the front end side of the top plate part 3a.

A first sensor 7 and a second sensor 8 are mechanical contact switches which are provided with a lever member and a contact part. The first sensor 7 and the second sensor 8 in this embodiment are a contact switch having water proofing property. The first sensor 7 and the second sensor 8 are, as shown in FIGS. 1 and 4, fixed to the right side face of the side plate part 3b. Specifically, as shown in FIG. 4, the first sensor 7 is fixed to the upper end of the first groove part 3g of the guide groove 3e and the second sensor 8 is fixed to the upper end of the second groove part 3h of the guide groove 3e. In this embodiment, the engaging pin 13 fixed to the ice tray 2 is abutted with the lever member of the first sensor 7 to press the contact part and, as a result, the ice tray 2 is detected to be located at the ice making position. Further, the engaging pin 13 is abutted with the lever member of the second sensor 8 to press the contact part and, as a result, the ice tray 2 is detected to be located at the water-supply position.

A third sensor 10 is, similarly to the first sensor 7 and the second sensor 8, a mechanical contact switch which is provided with a lever member and a contact part. The third sensor 10 in this embodiment is also a contact switch having water proofing property. The third sensor 10 is fixed to a right side face of the gear mechanism 20. In this embodiment, the sensor abutting part 45b of the lever turning shaft 45 structuring the gear mechanism 20 is abutted with the lever member of the third sensor 10 to press the contact part and, as a result, it is detected that a remaining amount of ice pieces in the ice storage container is a little.

In this embodiment, when the engaging pin 13 is disposed at the upper end of the first groove part 3g and the engaging tube 14 is disposed at the upper end of the first groove part 3j, the cooling bodies 22 are entered into the ice tray 2. In other words, at this position, the ice tray 2 is located at the ice making position. Further, when the engaging pin 13 is disposed at the upper end of the second groove part 3h of the guide groove 3e and the engaging tube 14 is disposed at the upper end of the second groove part 3k of the guide groove 3f, the ice tray 2 is disposed at the lower side of the water-supply part 3d. In other words, at this position, the ice tray 2 is located at the water-supply position.

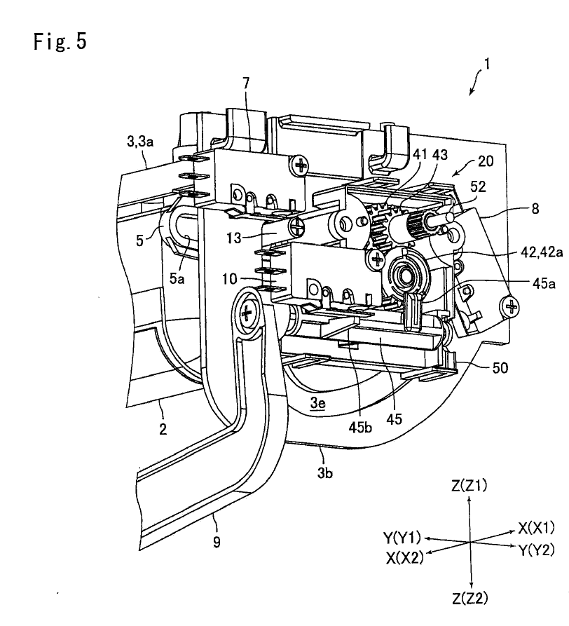

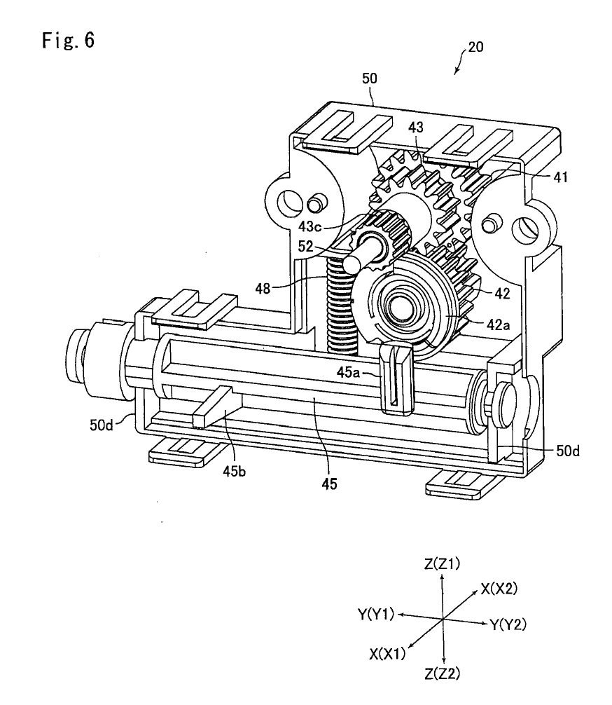

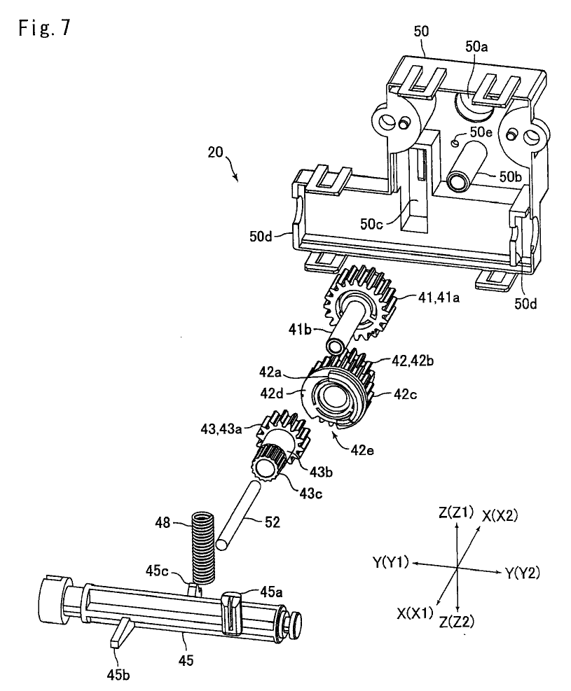

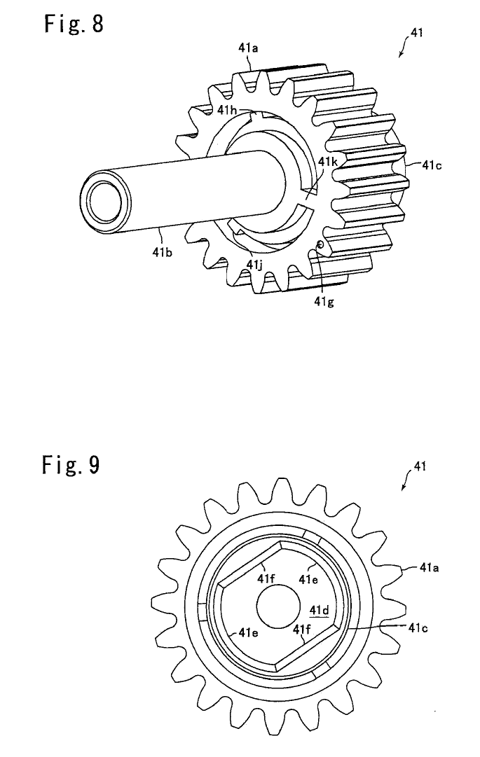

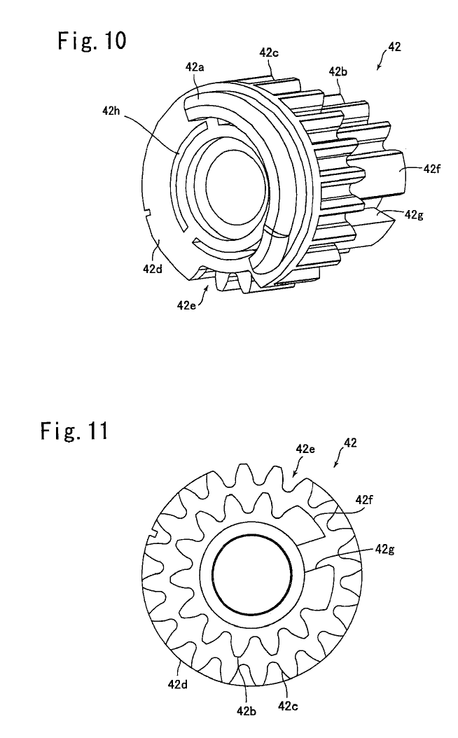

FIG. 5 is a perspective view showing a state where the motor 19, a cover member 51 and the like are detached from the ice making device 1 shown of FIG. 1, and which is viewed from a different direction. FIG. 6 is a perspective view showing the gear mechanism 20 shown in FIG. 5. FIG. 7 is an exploded perspective view showing the gear mechanism 20 shown in FIG. 6. FIG. 8 is a perspective view showing a first gear 41 shown in FIG. 7. FIG. 9 is a left side view showing the first gear 41 shown in FIG. 7. FIG. 10 is a perspective view showing a second gear 42 in FIG. 7. FIG. 11 is a left side view showing the second gear 42 in FIG. 7.

As shown in FIGS. 6 and 7, the gear mechanism 20 is provided with three gears, which are a first gear 41, a second gear 42 and a third gear 43, a lever turning shaft 45 for turning the ice detecting lever 9, and a compression coil spring 48 for urging the lever turning shaft 45 in a direction which moves the ice detecting lever 9 downward. These structural elements are accommodated in a box-shaped case body 50 whose right side face is opened. Further, the right side face of the case body 50 is closed by a cover member 51 (see FIG. 4). The first gear 41, the second gear 42 and the third gear 43 in this embodiment are formed of resin.

A through-hole penetrating in an axial direction is formed at an axial center of the first gear 41. The first gear 41 is, as shown in FIGS. 7 and 8, structured of a gear part 41a formed with a plurality of teeth a small diameter tube part 41b in a cylindrical shape which is protruded to the right side from a right side face of the gear part 41a so as to serve as a rotation support part for the third gear 43, and a large diameter tube part 41c in a cylindrical shape which is protruded from a left side face of the gear part 41a to the left side. The gear part 41a, the small diameter tube part 41b and the large diameter tube part 41c are coaxially disposed. Further, an outer diameter of the small diameter cylindrical part 41b is set to be smaller than an outer diameter of the large diameter cylindrical part 41c.

As shown in FIG. 9, a shaft engaging recessed part 41d, which is an engaging part with which a right-side end of the crank turning shaft 17 is engaged, is formed at a left end face of the first gear 41, i.e., the large diameter cylindrical part 41c so as to recess in the right direction A side face of the shaft engaging recessed part 41d is structured of two curved face parts 41e and two flat face parts 41f so that power can be transmitted from the first gear 41 to the crank turning shaft 17. In other words, an outer peripheral face of the crank turning shaft 17 is also structured of two curved face parts and two flat face parts. The two curved face parts 41e are formed to be faced each other and the two flat face parts 41f are formed to be faced each other. As a result, when the crank turning shaft 17 is engaged with the shaft engaging recessed part 41d, rotation is transmitted from the first gear 41 to the crank turning shaft 17.

As shown in FIG. 8, a small circular recessed part 41g is formed on a right side face of the gear part 41a so as to recess in the left direction. Further, an inside portion in a radial direction of a right side face of the gear part 41a is formed with a thickness reducing recessed part in the first gear 41 which is made of resin. As shown in FIG. 8, three ribs 41h, 41j and 41k for reinforcement are formed with an interval of 120° (120 degree) in the thickness reducing recessed part. Right end faces of two ribs 41h and 41j of three ribs 41h, 41j and 41k are recessed from a right side face of the gear part 41a. On the other hand, a right end face of the remaining rib 41k is disposed on the same flat face as the right side face of the gear part 41a.

In this embodiment, when the first gear 41 is to be mounted on the case body 50, positioning in a circumferential direction of the first gear 41 to the case body 50 is determined with the circular recessed part 41g and/or the rib 41k as a mark In other words, the circular recessed part 41g and/or the rib 41k in this embodiment is formed at a predetermined position with respect to the shaft engaging recessed part 41d with which the crank turning shaft 17 is engaged and thus the circular recessed part 41g and/or the rib 41k are a mark part for positioning the first gear 41 to the case body 50 in the circumferential direction. When the position of the first gear 41 to the case body 50 is determined in the circumferential direction the position of the shaft engaging recessed part 41d with which the crank turning shaft 17 is engaged is also determined.

A through-hole penetrating in an axial direction is formed at a shaft center of the second gear 42. Further, the second gear 42 is structured of a small gear part 42b engaged with the first gear 41, a large gear part 42c whose diameter is larger than the small gear part 42b and which is engaged with the third gear 43, and a flange part 42d for forming a cam on which a cam 42a for turning the lever turning shaft 45 is formed. The small gear part 42b and the large gear part 42c are coaxially disposed so as to be superposed on each other in the axial direction. In this embodiment, the small gear part 42b is formed so as to protrude from a left side face of the large gear part 42c to the left side.

As shown in FIG. 10, a right end face of the second gear 42 (end face on the large gear part 42c side) is formed with the flange part 42d for forming a cam so as to extend in the radial direction. The flange part 42d is formed in a roughly circular plate shape and a diameter of the flange part 42d is set to be substantially equal to a diameter of tooth tip parts of the large gear part 42c. The cam 42a for turning the lever turning shaft 45 is formed on the flange part 42d so as to protrude in the right direction and a face of the flange part 42d where the cam 42a is not formed is a bottom face to the cam 42a. The cam 42a is formed in a semicircular shape when viewed from the axial direction of the second gear 42, and a thickness reducing recessed part 42h in the second gear 42 which is made of resin is formed on an inner side of the cam 42a.

Further, the flange part 42d is formed with a cut-out part 42e for being capable of engaging the third gear 43 with the large gear part 42c of the second gear 42 from the flange part 42d side of the second gear 42. The cut-out part 42e is, as shown in FIG. 10, formed in a part of a portion of the flange part 42d where the cam 42a is not formed. The cut-out part 42e is formed so as to cut out from an outer peripheral end of the flange part 42d toward the inside in the radial direction. Specifically, the cut-out part 42e is formed so as to cut out from the outer peripheral end of the flange part 42d to the tooth bottom of the large gear part 42c, and thus the third gear 43 can be engaged with the large gear part 42c of the second gear 42 from the flange part 42d side.

In this embodiment a rotation range of the second gear 42 at the time when the ice tray 2 is moved from the water-supply position to the ice making position (or from the ice making position to the water-supply position) is less than one revolution. Therefore, as shown in FIG. 11, a toothless part 42f where a tooth is not formed is formed in a part in a circumferential direction of the small gear part 42b. An outer peripheral face of the toothless part 42f is formed with a positioning recessed part 42g so as to recess toward an inner side in the radial direction with which a positioning pin 55 that is used at the time of assembling of the gear mechanism 20 is engaged.

A through-hole penetrating in an axial direction is formed at an axial center of the third gear 43. The small diameter tube part 41b of the first gear 41 is inserted into the through-hole and the third gear 43 is rotatably supported by the small diameter tube part 41b and thus the first gear 41 and the third gear 43 are coaxially disposed to each other as shown in FIG. 6. Further, an inner side diameter of the through-hole of the third gear 43 is set to be larger than an outer diameter of the small diameter tube part 41b, and the third gear 43 is relativity turnable with respect to the first gear 41.

The third gear 43 is, as shown in FIG. 7, structured of a gear part 43a in which a plurality of teeth are formed, a cylindrical pipe part 43b which protrudes to the right side from a right side face of the gear part 43a, and a serration 43c which is formed on a right end side of the pipe part 43b. The serration 43c is engaged with a serration structuring a deceleration mechanism for the motor 19 and the third gear 43 is connected with the motor 19.

A pin 52 for reinforcing the small diameter tube part 41b is inserted into the through-hole of the first gear 41.

The lever turning shaft 45 is disposed in the front and rear direction as its axial direction. The lever turning shaft 45 is, as shown in FIG. 7 and the like, formed with a cam abutting part 45a which is capable of abutting with the cam 42a, a sensor abutting part 45b which is capable of abutting with the third sensor 10, and a pushed part 45c which is pushed by a compression coil spring 48. The cam abutting part 45a, the sensor abutting part 45b and the pushed part 45c are formed so as to protrude toward an outer side in the radial direction. Further, as shown in FIG. 5, the ice detecting lever 9 is fixed to a front end of the lever turning shaft 45 and the ice detecting lever 9 is turned around the front and rear direction as its axial direction.

In this embodiment in a state where the ice detecting lever 9 is located at an upper position as described below, the sensor abutting part 45b does not abut with the lever member of the third sensor 10 and thus the third sensor 10 is in an “OFF” state. Further, when the ice detecting lever 9 is moved down, the sensor abutting part 45b is abutted with the lever member of the third sensor 10 to turn the third sensor 10 in an “ON” state.

As described above, the compression coil spring 48 urges the lever turning shaft 45 in a direction where the ice detecting lever 9 is moved downward. Further, the compression coil spring 48 urges the lever turning shaft 45 in a direction where the cam abutting part 45a is moved to the cam 42a.

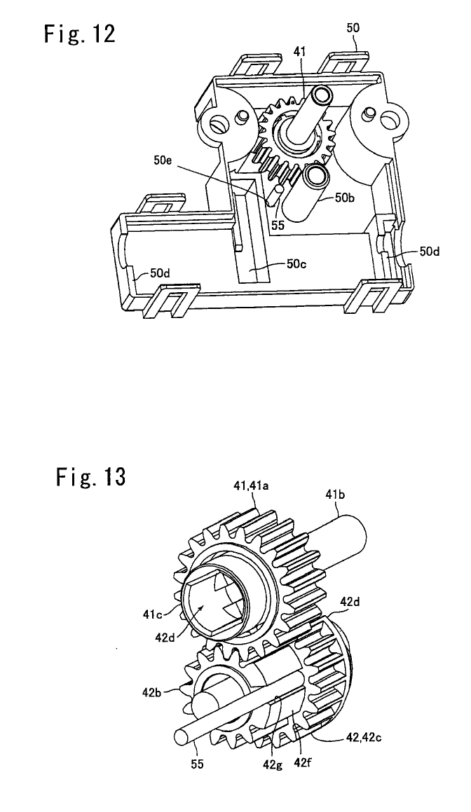

As shown in FIG. 7, the case body 50 is formed with an arrangement hole 50a on which the large diameter tube part 41c of the first gear 41 is disposed and a tube part 50b which is inserted into the inner peripheral side of the second gear 42 to serve as a rotation support part for the second gear 42. The first gear 41 and the second gear 42 are rotatably mounted on the case body 50. Further, the case body 50 is formed with a spring arranging recessed part 50c in which the compression coil spring 48 is disposed, and shaft support parts 50d which support both ends of the lever turning shaft 45. In addition, the case body 50 is formed with an insertion hole 50e into which a positioning pin 55 is inserted (see FIG. 12) for determining the position of the second gear 42 in a circumferential direction at the time of assembling of the second gear 42.

The cover member 51 is, as shown in FIG. 4, formed with an arrangement hole 51a in which the sensor abutting part 45b of the lever turning shaft 45 is disposed.

As described above, the first gear 41 is formed with the shaft engaging recessed part 41d with which the right end of the crank turning shaft 17 is engaged In other words, the crank 5 fixed to the crank turning shaft 17 is turned by rotation of the first gear 41 to move the ice tray 2. The ice tray 2 in this embodiment is a first drive object which is operated by turning of the first gear 41.

Further, as described above, the flange part 42d of the second gear 42 is formed with the cam 42a for turning the lever turning shaft 45. In other words, the ice detecting lever 9 fixed to the lever turning shaft 45 is turned by turning of the second gear 42. The ice detecting lever 9 in this embodiment is a second drive object which is operated by turning of the second gear 42.

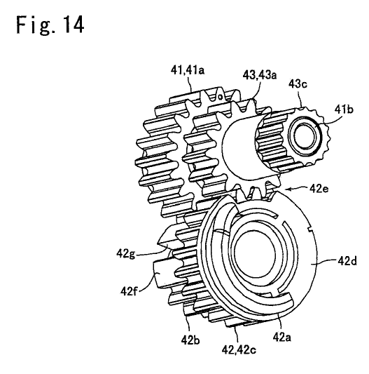

FIG. 12 is a perspective view for explaining a step in which the first gear 41 and the second gear 42 are mounted on the case body 50 shown in FIG. 7. FIG. 13 is a perspective view for explaining a step in which the second gear 42 is mounted on the case body 50 shown in FIG. 7. FIG. 14 is a perspective view for explaining a step in which the second gear 42 and the third gear 43 shown in FIG. 7 are engaged with each other.

The gear mechanism 20 will be assembled as described below. In this embodiment, the ice detecting lever 9 and the ice tray 2 are to be interlocked with each other. Therefore, in order to adequately interlock the ice tray 2 and the ice detecting lever 9 with each other, at the time of assembling of the gear mechanism 20, positional alignment of the position in the circumferential direction of the first gear 41 for moving the ice tray 2 with the position in the circumferential direction of the second gear 42 for moving the ice detecting lever 9 is performed. Specifically, positional alignment of the position in the circumferential direction of the shaft engaging recessed part 41d structured of two curved face parts 41e and two flat face parts 41f with the position in the circumferential direction of the cam 42a is performed.

First, in order to perform the positional alignment of the position in the circumferential direction of the shaft engaging recessed part 41d structured of two curved face parts 41e and two flat face parts 41f with the position in the circumferential direction of the cam 42a, a shaft for assembling (not shown) having the same shape as the crank turning shaft 17 is inserted into the arrangement hole 50a of the case body 50 from the left side face of the case body 50. Further, the positioning pin 55 for determining the second gear 42 in the circumferential direction is inserted into the insertion hole 50e of the case body 50 from the left side face of the case body 50 (see FIG. 12). In this case, the shaft for assembling is set in the arrangement hole 50a so that two curved face parts and two flat face parts formed on the outer peripheral face of the shaft for assembling with which the shaft engaging recessed part 41d is engaged are set to be at an appropriate position in the circumferential direction with respect to the case body 50.

After that, the first gear 41 is mounted on the case body 50 (first gear mounting step). Specifically, since the circular recessed part 41g and/or the rib 41k are formed at the predetermined positions with respect to the shaft engaging recessed part 41d with which the crank turning shaft 17 is engaged, the position in the circumferential direction of the first gear 41 is determined with the circular recessed part 41g and/or the rib 41k as a mark and the shaft engaging recessed part 41d of the first gear 41 is engaged with the shaft for assembling.

After that, the second gear 42 is mounted on the case body 50 (second gear mounting step). Specifically, as shown in FIG. 13, the position in the circumferential direction of the second gear 42 is determined so that the positioning pin 55 is engaged with the positioning recessed part 42g of the second gear 42 and then the second gear 42 is fitted to the tube part 50b of the case body 50. The position of the insertion hole 50e formed in the case body 50 into which the positioning pin 55 for determining the second gear 42 is inserted is, as described above, formed at the position for determining the position in the circumferential direction of the second gear 42 through the positioning recessed part 42g of the second gear 42 when the position in the circumferential direction of the first gear 41 is determined. Therefore, when the second gear 42 is fitted to the tube part 50b of the case body 50, the positioning recessed part 42g and the positioning pin 55 are engaged with each other and thus the gear part 41a of the first gear 41 and the small gear part 42b of the second gear 42 are engaged with each other. Further, when the second gear 42 is fitted to the tube part 50b of the case body 50 so that the positioning recessed part 42g and the positioning pin 55 are engaged with each other, the position in the circumferential direction of the shaft engaging recessed part 41d of the first gear 41 and the position in the circumferential direction of the cam 42a of the second gear 42 are rightly aligned with each other.

After that, the third gear 43 is fitted to the small diameter tube part 41b of the first gear 41 (third gear mounting step). In this case, as shown in FIG. 14, the large gear part 42c of the second gear 42 and the gear part 43a of the third gear 43 are engaged with each other by utilizing the cut-out part 42e of the second gear 42.

After that, when the lever tuning shaft 45, the compression coil spring 48 and the like are mounted and the right side face of the case body 50 is closed with the cover member 51, the gear mechanism 20 is completed. In accordance with an embodiment of the present invention, after the second gear mounting step or, after the third gear mounting step, or after the right side face of the case body 50 has been closed with the cover member 51, the shaft for assembling is pulled out from the arrangement hole 50a and the positioning pin 55 is pulled out from the insertion hole 50e.

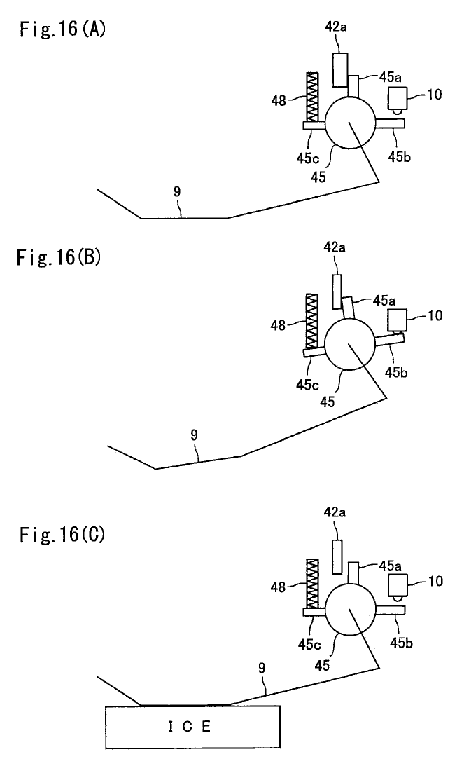

FIGS. 15(A) through 15(E) are views for explaining an ice making operation in the ice making device 1 shown in FIG. 1. FIGS. 16(A) through 16(C) are views for explaining movement of the ice detecting lever 9 shown in FIG. 1.

In the ice making device 1 structured as described above, ice pieces are made as follows. First as shown in FIG. 15(A), water is supplied into the ice tray 2 located at the water-supply position. In other words, water is supplied into the ice tray 2 which is disposed on an under side of the water-supply part 3d.

Next, the cranks 5 are turned to move the ice tray 2 to the ice making position where the engaging pin 13 is disposed on the upper end of the first groove part 3g and the engaging tube 14 is disposed on the upper end of the first groove part 3j (see FIG. 15(B)). When the ice tray 2 is moved to the ice making position, the cooling bodies 22 enter into the ice tray 2. In this state, refrigerant is passed through the refrigerant pipe 23 to cool the cooling bodies 22 and water in the ice tray 2 is frozen.

Next, as shown in FIG. 15(C), the heater 15 is set to be an “ON” state. When the heater 15 is turned on, a contacting portion of ice with the ice tray 2 is melted. Next, as shown in FIG. 15(D), the cranks 5 are turned to move the ice tray 2 to the water-supply position In the state where the ice tray 2 has been moved to the water-supply position, ice sticks to the cooling body 22. After that, as shown in FIG. 15(E), the heater 24 is set to be an “ON” state and the cooling bodies 22 are heated. When the cooling bodies 22 are heated, the ice pieces which have been stuck to the cooling bodies 22 drop into the ice storage container.

The ice making operation described above is performed when a remaining amount of ice pieces is a little in the ice storage container. Specifically, a remaining amount of ice pieces in the ice storage container is detected as described below to determine whether the ice making operation is required or not. In other words, as shown in FIG. 16(A), first, when the ice tray 2 is located at the water-supply position, the cam abutting part 45a is abutted with the cam 42a and the ice detecting lever 9 is located at an upper position. In this case, the sensor abutting part 45b is not abutted with the lever member of the third sensor 10 and the third sensor 10 is in an “OFF” state.

In this state, when the motor 19 is driven in order to move the ice tray 2 to the ice making position, the gear mechanism 20 is operated and, as shown in FIGS. 16(B) and 16(C), the cam 42a is retreated. In other words, the cam 42a is retreated in cooperation with movement of the ice tray 2. When the cam 42a is retreated, the detection lever 9 becomes capable of turning with the lever tuning shaft 45 as its turning center in a direction where its tip end side is moved downward. In other words, the detection lever 9 becomes to be capable of tuning in cooperation with movement of the ice tray 2.

When a remaining amount of ice pieces in the ice storage container is a little or there is no ice piece in the ice storage container, as shown in FIG. 16(B), the detection lever 9 is moved down by an urging force of the compression coil spring 48 and the own weight of the detection lever 9 and the sensor abutting part 45b is abutted with the lever member of the third sensor 10 to change the third sensor 10 into an “ON” state. When the third sensor 10 is turned to be an “ON” state, it is judged that a remaining amount of ice pieces in the ice storage container is a little, in other words, it is judged that an ice making operation is required and thus the ice tray 2 is continuously moved as it is to the ice making position to perform an ice making operation.

On the other hand, in a case that a remaining amount of ice pieces in the ice storage container is much even when the cam 42a is retreated, as shown in FIG. 16(C), the detection lever 9 is contacted with ice pieces in the ice storage container and is not moved down. Therefore, the sensor abutting part 45b is not abutted with the lever member of the third sensor 10 and thus the third sensor 10 is not turned in an “ON” state. When the third sensor 10 is not turned in an “ON” state, it is judged that a remaining amount of ice pieces in the ice storage container is much, in other words, it is judged that an ice making operating is not required and then, the ice tray 2 is returned to the water-supply position again to stand by.

In this embodiment, the ice tray 2 normally stands by at the water-supply position. Further, in this embodiment the ice tray 2 starts to move to the ice making position with a regular interval and, when an ice making operation is required, the ice tray 2 is continuously moved to the ice making position and, when an ice making operation is not required, the ice tray 2 is returned to the water-supply position again.

As described above, in the embodiment described above, the flange part 42d which is formed on the right-side end face of the second gear 42 is formed with the cutout part 42e for engaging the large gear part 42c with the third gear 43. Therefore, even when the small gear part 42b and the large gear part 42c are disposed so as to be superposed on each other in the axial direction and the flange part 42d is formed on the right-side end face of the second gear 42, the third gear 43 and the large gear part 42c are engaged with each other after the first gear 41 and the small gear part 42b have been engaged with each other. In other words, in order to properly operate the ice tray 2 and the ice detecting lever 9 which are interlocked with each other, after the first gear 41 and the second gear 42 whose relative positioning are required each other have been aligned with each other, the third gear 43 and the large gear part 42c whose relative positioning are not required are engaged with each other. Accordingly, in this embodiment, positioning of the first gear 41 with respect to the second gear 42 is easily performed and thus assembling of the gear mechanism 20 becomes easy.

In the embodiment described above, the flange part 42d is formed with the cam 42a for turning the lever turning shaft 45. Therefore, in comparison with a case that a cam is formed on the left-side end face of the second gear 42, the cam 42a is formed with a high degree of accuracy. Further, in this embodiment, since the turning range of the second gear 42 is less than one revolution, the cutout part 42e is formed by utilizing a portion of the flange part 42d where the cam 42a is not formed.

In the embodiment described above, the case body 50 is formed with the insertion hole 50e into which the positioning pin 55 for determining the position in the circumferential direction of the second gear 42 is inserted and the positioning recessed part 42g with which the positioning pin 55 is engaged is formed in the small gear part 42b of the second gear 42. Further, in the second gear mounting step, in the state where the positioning pin 55 is inserted into the insertion hole 50e, the second gear 42 is mounted on the case body 50 so that the positioning pin 55 and the positioning recessed part 42g are engaged with each other. Therefore, the position of the second gear 42 to the case body 50 is easily determined by utilizing the positioning pin 55 which is inserted into the insertion hole 50e. In this embodiment, the positioning pin 55 is pulled out from the insertion hole 50e after assembling of the gear mechanism 20 and thus the positioning pin 55 does not affect the operation of the gear mechanism 20.

In the embodiment described above, the positioning recessed part 42g is formed on the outer peripheral face of the toothless part 42f which is formed in the small gear part 42b. Therefore, the positioning recessed part 42g is formed by utilizing the toothless part 42f which is not used for the operation of the gear mechanism 20. Accordingly, the structure of the second gear 42 can be simplified. Further, the size of the second gear 42 can be reduced in the radial direction

In the embodiment described above, the first gear 41 is formed with the circular recessed part 41g and the rib 41k. Further, in the first gear mounting step, the position in the circumferential direction of the first gear 41 is determined with the circular recessed part 41g and/or the rib 41k as a mark and the shaft engaging recessed part 41d of the first gear 41 is fitted to the shaft for assembling. Therefore, the position of the first gear 41 to the case body 50 is easily determined by utilizing the circular recessed part 41g and/or the rib 41k which are mark parts for determining the position in the circumferential direction of the first gear 41 with respect to the case body 50.

In the embodiment described above, the compression coil spring 48 urges the lever tuning shaft 45 in the direction where the cam abutting part 45a is directed toward the cam 42a. Therefore, even when the own weight of the ice detecting lever 9 is light, the cam abutting part 45a is capable of being securely abutted with the cam 42a. Further, even when the spring force of the lever member of the third sensor 10 is strong, the sensor abutting part 45b is capable of pressing the lever member of the third sensor 10 to properly operate the third sensor 10.

In the embodiment described above, the third sensor 10 is fixed to the right side face of the gear mechanism 20. Therefore, in comparison with a case that a sensor for detecting the position of the ice detecting lever 9 is disposed in the inside of the gear mechanism 20, an exchanging work of the third sensor 10 is easy.

Although the present invention has been shown and described with reference to specific embodiments, various changes and modifications will be apparent to those skilled in the art from the teachings herein.

In the embodiment described above, the first gear 41 and the third gear 43 are coaxially disposed on each other. However, it may be structured that a mounting part for the third gear 43 is formed on the case body 50 and the first gear 41 and the third gear 43 are disposed on different shafts. Further, in the embodiment described above, the positioning recessed part 42g with which the positioning pin 55 is engaged is formed on the outer peripheral face of the toothless part 42f so as to recess on the inner side in the radial direction. However, the positioning recessed part with which the positioning pin 55 is engaged may be formed so as to recess toward the right side from the left-side end face of the second gear 42.

In the embodiment described above, a rotation range of the second gear 42 when the ice tray 2 is moved from the water-supply position to the ice making position (or from the ice making position to the water-supply position) is set to be less than one revolution However, the rotation range of the second gear 42 when the ice tray 2 is moved from the water-supply position to the ice making position (or from the ice making position to the water-supply position) may be set more than one revolution. Further, in the embodiment described above, the third sensor 10 is a mechanical contact switch but may be an optical sensor provided with a light emitting element and a light receiving element or may be a magnetic sensor having a Hall IC and the like.

In the embodiment described above, the gear mechanism 20 in accordance with the embodiment of the present invention is utilized as an example in the ice making device 1 but the gear mechanism 20 may be utilized in various devices other than the ice making device 1.

While the description above refers to particular embodiments of the present invention, it will be understood that many modifications may be made without departing from the spirit thereof. The accompanying claims are intended to cover such modifications as would fall within the true scope and spirit of the present invention.

The presently disclosed embodiments are therefore to be considered in all respects as illustrative and not restrictive, the scope of the invention being indicated by the appended claims, rather than the foregoing description, and all changes which come within the meaning and range of equivalency of the claims are therefore intended to be embraced therein.

What is claimed is:

1. A gear mechanism comprising:
a first gear for operating a first drive object;
a second gear for operating a second drive object in cooperation with the first drive object; and
a third gear which is connected with a drive source;
wherein the second gear comprises:
a small gear part which is engaged with the first gear; and
a large gear part having a diameter larger than the small gear part and which is engaged with the third gear,
wherein the small gear part and the large gear part are disposed so as to be superposed on each other in an axial direction; and
wherein an end face of the second gear on a large gear part side is formed with a flange part, and the flange part is formed with a cutout part for allowing the large gear part to engage with the third gear.

2. The gear mechanism according to claim 1, wherein the first gear and the third gear are coaxially disposed on each other.

3. The gear mechanism according to claim 2, further comprising
an engagement part, which is formed on a face of the first gear opposite to a side where the third gear is disposed, for being engaged with the first drive object to operate the first drive object; and
a cam part which is formed on the flange part for operating the second drive object;
wherein the flange part is formed in a larger diameter than a tooth bottom of the large gear part, and the cutout part which is formed in the flange part is formed at a different position in a circumferential direction from the cam part so that the tooth bottom of the large gear part is exposed.

4. The gear mechanism according to claim 1, further comprising a cam part which is formed on the flange part for operating the second drive object.

5. The gear mechanism according to claim 4, wherein a rotation range of the second gear is less than one revolution.

6. The gear mechanism according to claim 1, further comprising
a case body on which the first gear and the second gear are turnably mounted; and
an insertion hole which is formed in the case body and structured to receive a positioning pin determining a position in a circumferential direction of the second gear.

7. The gear mechanism according to claim 6, further comprising a positioning recessed part which is formed in the small gear part of the second gear and structured to engage with the positioning pin.

8. The gear mechanism according to claim 7, wherein
a rotation range of the second gear is less than one revolution,
the small gear part is formed with a toothless part where a tooth is not formed, and
the positioning recessed part is formed on an outer peripheral face of the toothless part.

9. The gear mechanism according to claim 1, further comprising
a case body on which the first gear and the second gear are turnably mounted; and
a mark part which is formed on the first gear for determining a position in a circumferential direction of the first gear with respect to the case body.

10. The gear mechanism according to claim 9, wherein the first gear and the third gear are coaxially disposed on each other.

11. The gear mechanism according to claim 10, further comprising an insertion hole which is formed in the case body and structured to receive a positioning pin for determining a position in a circumferential direction of the second gear.

12. The gear mechanism according to claim 11, further comprising
an engagement part, which is formed on a face of the first gear opposite to a side where the third gear is disposed, for being engaged with the first drive object to operate the first drive object;
a cam part which is formed on the flange part for operating the second drive object; and
wherein a position in a circumferential direction of the engagement part for operating the first drive object is determined by utilizing the mark part formed on the first gear which is set at a predetermined position in a circumferential direction of the first gear,
wherein a position in the circumferential direction of the second gear is determined by the positioning pin,
thereby the position of the engagement part for operating the first drive object and the position of the cam part for operating the second drive object are set in a predetermined positional relationship.

13. An ice making device comprising:
a gear mechanism comprising:
a first gear for operating a first drive object;
a second gear for operating a second drive object in cooperation with the first drive object; and
a third gear which is connected with a drive source;
wherein the second gear comprises:
a small gear part which is engaged with the first gear; and
a large gear part having a diameter larger than the small gear part and which is engaged with the third gear;
wherein the small gear part and the large gear part are disposed so as to be superposed on each other in an axial direction, and
wherein an end face of the second gear on a large gear part side is formed with a flange part, and the flange part is formed with a cutout part for engaging the large gear part with the third gear,
wherein the first drive object is provided with an ice tray and the second drive object is provided with an ice detecting lever for detecting a remaining amount of ice pieces in an ice storage container in which ice pieces made in the ice tray are stored.

14. The ice making device according to claim 13, further comprising
a crank which is engaged with the ice tray for moving the ice tray to a water-supply position where water is supplied into the ice tray and to an ice making position where water in the ice tray is frozen;
a crank tuning shaft by which the crank is turned; and
a lever turning shaft by which the ice detecting lever is turned;
wherein the first gear is formed with a shaft engaging recessed part with which an end part of the crank turning shaft is engaged and the flange part is formed with a cam for turning the lever turning shaft.

15. An assembling method for a gear mechanism comprising:
providing a first gear for operating a first drive object;
providing a second gear for operating a second drive object in cooperation with the first drive object;
wherein the second gear comprises:
a small gear part which is engaged with the first gear; and
a large gear part having a diameter larger than the small gear part;
wherein the small gear part and the large gear part are disposed so as to be superposed on each other in an axial direction; and
wherein an end face of the second gear on a large gear part side is formed with a flange part and the flange part is formed with a cutout part; and
providing a third gear which is connected with a drive source and which is engaged with the large gear part of the second gear;
mounting the first gear on a case body;
after the mounting the first gear, mounting the second gear on the case body to engage the first gear with the small gear part;
after the mounting the second gear, engaging the third gear with the large gear part through the cutout part.

16. The assembling method for a gear mechanism according to claim 15, further comprising:
forming an insertion hole in the case body, the insertion hole being structured to receive a positioning pin for determining a position in a circumferential direction of the second gear; and
forming a positioning recessed part in the small gear part of the second gear, the positioning recessed part being structured to engage with the positioning pin;
wherein in a state where the positioning pin is inserted into the insertion hole, the second gear is mounted on the case body so that the positioning pin and the positioning recessed part are engaged with each other.

17. The assembling method for a gear mechanism according to claim 15, further comprising:
forming a mark part on the first gear for determining a position in a circumferential direction of the first gear with respect to the case body;
wherein the first gear is mounted on the case body with the mark part as a mark.

18. The assembling method for a gear mechanism according to claim 17, further comprising:
forming an engagement part on a face of the first gear opposite to a side where the third gear is disposed, the engagement part being engaged with the first drive object to operate the first drive object;
forming the mark part which is formed on the first gear at a position in a circumferential direction of the first gear at a predetermined position so that a position in a circumferential direction of the engagement part for operating the first drive object is determined at a predetermined position;
forming a cam part on the flange part for operating the second drive object;
forming an insertion hole in the case body, the insertion hole being structured to receive a positioning pin for determining a position in a circumferential direction of the second gear,
forming a positioning recessed part in the small gear part of the second gear, the positioning recessed part being structured to engage with the positioning pin;
setting the first gear at a predetermined position in the circumferential direction of the first gear by utilizing the mark part; and
setting the second gear at a predetermined position in the circumferential direction of the second gear by engaging the positioning pin with the positioning recessed part in a state where the positioning pin is inserted into the insertion hole;
thereby the position of the engagement part for operating the first drive object and the position of the cam part for operating the second drive object are set in a predetermined positional relationship.
